(19) United States
(12) Patent Application Publication
(10) Pub. No.: US 2013/0199506 A1
(43) Pub. Date: Aug. 8, 2013

(54) DUAL FUNCTION BREATHER BYPASS SYSTEM

(71) Applicant: Jorge Fernandez, Chicago, IL (US)

(72) Inventor: Jorge Fernandez, Chicago, IL (US)

(73) Assignee: INTERNATIONAL ENGINE INTELLECTUAL PROPERTY COMPANY LLC, Lisle, IL (US)

(21) Appl. No.: 13/806,220

(22) PCT Filed: Jun. 30, 2010
(86) PCT No.: PCT/US2010/040630

§ 371 Date: Mar. 15, 2013

(51) Int. Cl. F02B 47/00

(52) U.S. Cl. CPC F02B 47/00
USPC 123/572

(57) ABSTRACT

A breather system functions, under high load conditions, as an open breather system, and functions as a closed breather system under low load conditions. The breather system includes a first flow path between the engine crankcase and an air intake for the engine, and a three-way valve mechanism located within the flow path and responsive to air intake depression pressure to close the pathway leading to the air intake and allow for a second flow path between the engine chamber and atmosphere to function as an open breather system. When the air intake depression pressure in the air intake is such that the valve leading to the air intake is open, the system operates as a closed breather system.

### FIELD OF THE INVENTION

This invention relates to internal combustion engines, including but not limited to recirculation of crankcase gases into the intake system of an engine.

### BACKGROUND

The present invention relates to a closed breather system for a crankcase of an internal combustion engine of the type which recirculates piston blow-by gases in the crankcase to the intake air line of an engine and, more particularly, to a breather system capable of forming an open loop breather system under high loads, and a closed loop breather system under light loads.

Ideally, the pressure within an internal combustion engine crankcase should be maintained at a level equal to or slightly less than atmospheric pressure to prevent external oil leakage through the various gasketed joints, such as that between the valve cover and the cylinder head. Combustion gases are generated during the operation of an internal combustion engine. A small amount of these gases leaks past the piston seals of the internal combustion engine, and unless the gases are removed from the crankcase, they become trapped. These gases, commonly referred to in the art as “blow-by” gases, need to be released. Because of the “blow-by” gases, the crankcase pressure will inherently rise, promoting leakage of oil from the crankcase. Originally, crankcase pressure was vented to the atmosphere through a breather to solve this problem.

Environmental considerations dictate that the blow-by gases in the crankcase be vented back to the combustion chamber rather than being released to the atmosphere. Accordingly, the crankcase was scavenged by being connected to the engine air intake thereby resulting in a vacuum in the crankcase with a depression valve being used to prevent the negative pressure in the engine cavity from exceeding a predetermined amount.

Government regulations require the engine to be within defined levels of exhaust emissions, including crankcase vapors, under specific environmental conditions which include ambient temperature and altitude. Outside of the specified environmental conditions, the “emissions window” the engine is allowed to have different emission levels.

The present inventor has recognized that highly turbocharged engines with closed breather systems suffer from ongoing turbocharger compressor “coking”—a varnish like residue that results when oil and fuel molecules in blow-by gasses come in contact with hot turbocharger compressor surfaces and oxidizes, which builds up over time and eventually affects turbocharger efficiency. Thus, it is desirable to have breather systems capable of alternating between operation as a closed breather system and as an open breather system to lessen the impact of coking resulting from operation under only a closed breather system.

Current breather bypass valves that attempt to allow for alternation between a closed breather system and an open breather system can be cumbersome, expensive, and require a boost supply for actuation.

The present inventor has recognized the need for a simple, easily packageable, self-contained valve that does not require an external boost supply, which opens the breather at higher load and higher speeds, while maintaining a closed breather system at lower loads and lower speeds.

The present inventor has recognized the need for an engine that helps meet EPA emission standards and prevent DOC/DPF Poisoning, while preventing degradation of turbocharger performance over time.

### SUMMARY

The exemplary embodiment of the invention provides a valve for a breather system that allows a breather system to alternate between a closed and open breather system according to the load and speed of the vehicle.

The exemplary system would function as a closed breather system at low speeds and low load conditions, and as an open system at high speeds and high loads. The exemplary system provides a dual function selection valve that responds to air intake pressure conditions.

An exemplary embodiment of the invention provides a dual function selection valve attached between a breather and turbocharger compressor air intake. The valve, responsive to air intake depression, is located within the blow-by gas flow path, downstream of the oil mist separator, and allows the blow-by gas to flow alternatively between a flow path conduit to the compressor air intake, and a second flow path between the engine compartment and atmosphere.

The system can comprise a three-way valve with a check valve and a one-way flow valve. The check valve and the one-way flow valve operate in conjunction with one another to allow the breather system to operate as a closed breather system under low speeds and low loads, and as an open breather system under high speed and high loads.

An exemplary method of the invention for operating an internal combustion engine includes the steps of:

providing a dual function selection valve located between a breather tube and a turbo air intake, the dual function selection valve comprising a check valve and a one way flow valve;

providing an outlet to atmosphere for the blow-by gas when the breather system operates as an open breather system;

providing an outlet to the turbo air intake when the breather system operates as a closed breather system;

operating as an open breather system when a depression in the turbo inlet is greater than a predetermined value; and

operating as a closed breather system when a depression in the turbo inlet is less than the predetermined value.

The steps of operating as an open or closed breather system can be managed by a check valve which opens and closes a conduit according to the level of turbo air intake depression.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a plan view of a turbocharged engine and shows schematically a crankcase breather system of the present invention engaged to and between a valve housing of the engine and the compressor air inlet line of a turbocharger; and

FIG. 2 is a schematic diagram of a dual function crankcase breather system of the present invention.

FIG. 3 is a schematic diagram of the passive bypass valve when the breather system is operating as a closed breather system.

FIG. 4 is a schematic diagram of the passive bypass valve when the breather system is operating as an open breather system.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

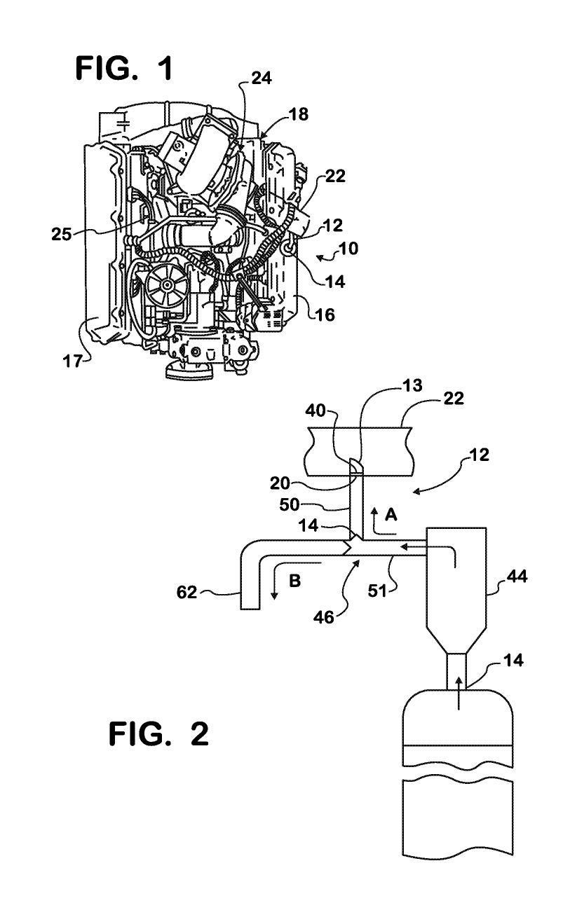

Referring now to the drawings in greater detail, there is illustrated therein a dual function breather bypass system of the present invention generally identified by the reference numeral 10 mounted on an internal combustion engine 18, preferably a diesel engine (FIG. 1).

The breather system 10 comprises a breather tube assembly 12 having an inlet end 14 in fluid communication with the interior of a valve housing 16 of engine 18 and an outlet end 20 (FIG. 2) in fluid communication with a tube fitting 13 mounted on an intake air line 22 of the engine 18 and extending therewithin. The valve housing 16 is the area beneath a rocker arm cover, and above a valve head. When the engine 18 is turbocharged as shown, tube fitting 13 is located in the compressor air inlet line to the turbocharger 24 (FIG. 1). In a naturally aspirated engine, the tube fitting 13 would be located in the intake air passage from the air cleaner.

In a V-8 engine, such as shown in FIG. 1, a crossover tube 25 interconnects the valve housing 16 with the rocker arm cover of the opposite valve housing 17 of the engine to equalize the pressure throughout the engine. It will be understood that the rocker arm covers define a portion of a closed interior cavity of the engine and that there is a continuous internal air path existing within and between the crankcase and the valve housings 16, 17. Thus, venting of one valve housing 16 will necessarily vent the interior of the crankcase as well as the other valve housing 17.

The tube fitting 13 includes an opening 40. A complete description on arrangement and structure of the tube fitting 13 can be found in U.S. Pat. No. 5,140,968, herein incorporated by reference.

The breather tube assembly 12 includes an oil mist separator 44 connected to a dual function selection valve 46 (FIG. 2). The dual function selection valve 46 is located between an upstream breather tube 51, and a downstream breather tube 50. Blow-by gas exiting the oil mist separator enters the upstream breather tube 51. The dual function selection valve 46 is also connected to the inlet end 14 of the downstream breather tube 50. The downstream breather tube 50 is connected to the tube fitting 13 via a fitting 54. The dual function selection valve is further connected to an outlet tube 62 through which blow-by gases flow during operation as an open breather system.

The oil mist separator 44 can be configured as described in U.S. Pat. No. 7,185,643, herein incorporated by reference.

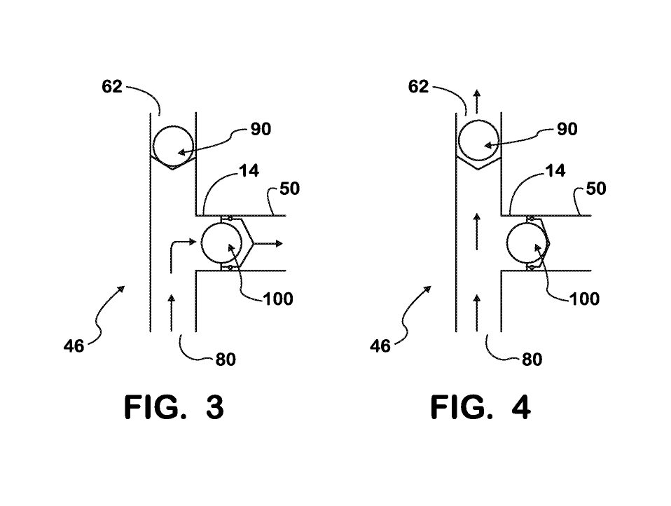

The dual function selection valve 46 can be a three-way valve, such as a T-valve, comprising a check valve 100 and a one-way flow valve 90 as illustrated in FIGS. 3 and 4. The check valve 100 can be a spring-loaded check valve that closes once a preset differential pressure is realized across the valve, such as 5 inches of H₂O. An open check valve, as illustrated in FIG. 3, allows blow-by gas leaving the oil mist separator 44 (FIG. 2) and entering the dual function selection valve 46 from the upstream breather tube 51 at inlet 80 to travel along path A to reach the air intake line 22 via downstream breather tube 50, thus operating as a closed breather system. A closed check valve, as illustrated in FIG. 4, allows blow-by gas leaving the oil mist separator 44 (FIG. 2) and entering the dual function selection valve 46 from the upstream breather tube 51 at inlet 80 to travel along path B to reach the outlet tube 62 for exit into atmosphere, thus operating as an open breather system.

The check valve opens and closes according to the pressure depression of the air intake line 22, and correspondingly the depression in the downstream breather tube 50, which are reflective of turbocharger conditions under high or low load operating conditions. Operation of the engine under high loads generates a stronger vacuum, thus resulting in greater air intake line 22 pressure depression than operation of the engine under lighter loads.

The check valve 100 automatically closes when the difference in pressure between the air intake line 22 and the blow-by pressure within breather tube 51 exceeds a preset differential pressure, for example, 5″ H₂O. Thus, when the turbocharger is spinning sufficiently to reduce the pressure (below atmospheric pressure) on the right side of the valve 100 to 5 inches of H₂O less than the pressure on the left side of the valve 100, the valve closes. When the check valve closes as illustrated in FIG. 4, the only flow path available to the blow-by gases in the dual function selection valve 46 will be along path B, which leads the blow-by gases to enter the outlet tube 62 via the one-way flow valve 90 to exit into the atmosphere as an open breather system. As blow-by gases enter the dual function selection valve 46, the blow-by gases may accumulate until sufficient pressure is reached to exit the one-way flow valve 90.

When the air intake line 22 depression is less than the preset differential pressure, the check valve is held open by its spring, as illustrated in FIG. 3. The open check value, coupled with the vacuum generated in the air intake line 22, and accordingly the downstream breather tube 50, causes the blow-by gas in the dual function selection valve 46 to flow down path A towards the air intake line 22 via the downstream breather tube 50, to operate as a closed breather system. The one-way flow valve 90 is held closed by positive pressure in the breather tube 51 and near atmospheric pressure in outlet tube 62. Thus the system is capable of self-regulating between a closed and open breather system as a result of the use of a intake-depression-sensitive check valve at the inlet 14 of the downstream breather tube 50, and the use of a one-way flow valve regulating the flow of blow-by gas into the outlet tube 62.

### PARTS LIST

10 breather system
12 breather tube assembly
13 tube fitting
14 inlet end of breather tube assembly
16 rocker arm cover
17 valve housing
18 internal combustion engine
20 outlet end of breather tube assembly
22 intake air line
24 turbocharger
25 crossover tube
44 oil mist separator
46 dual function selection valve
50 downstream breather tube
51 upstream breather tube
62 outlet tube
80 dual function selection valve inlet
90 one-way flow valve
100 check valve

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A breather system for a turbocharged internal combustion engine comprising:
a first flow path between an engine chamber subject to blow-by gasses and an air intake to a turbocharger for the engine;
a second flow path between the engine chamber and atmosphere; and
a valve mechanism responsive to air pressure in the air intake to close the first flow path and to open the second flow path.

2. The system according to claim 1, further comprising an oil mist separator in fluid communication with the first flow path.

3. The system according to claim 2, wherein the oil mist separator in fluid communication with the second flow path.

4. The system according to claim 1, wherein the valve mechanism comprises a one-way valve and a spring loaded check valve having a predetermined spring force holding the check valve open, the one way valve in the second flow path and the check valve in the first flow path.

5. The system according to claim 4, wherein the check valve closes when the differential air pressure across the check valve is greater than the spring force holding the check valve open.

6. The system according to claim 5, wherein the spring force is set to counteract a 5 inches of water differential pressure in a direction urging the valve closed.

7. A method of operating a piston blow-by system of a turbocharged internal combustion engine, the method eliminating piston blow-by gas from the engine to prevent a build up of gas pressure within a crankcase of the engine, comprising the steps of:
providing a first outlet from the crankcase to an air intake to the turbocharger when the breather system operates as a closed breather system;
providing a second outlet from the crankcase to atmosphere for engine blow-by gas when the breather system operates as an open breather system;
providing a valve within the first outlet;
operating as a closed breather system when the air pressure difference across the valve is less than the predetermined value; and
operating as an open breather system when the air pressure difference across the valve is greater than a predetermined value.

8. The method according to claim 7, wherein the predetermined value is 5″ H₂O.

9. The method according to claim 7, comprising the further step of separating oil mist within the open breather system, between the crankcase and the second outlet.

10. The method according to claim 7, comprising the further step of separating oil mist within the closed breather system, between the crankcase and the first outlet.

11. A breather system for a turbocharged internal combustion engine comprising:
a breather for separating oil from blow-by gasses, the breather having an inlet connected to a crankcase of an engine;
a first conduit between the breather and an air intake to a turbocharger for the engine;
a second conduit between the breather and atmosphere; and
a valve mechanism responsive to air pressure in the air intake to close the first conduit and to open the second conduit.

12. The system according to claim 11, wherein the valve mechanism comprises a one-way valve and a spring loaded check valve having a predetermined spring force holding the check valve open, the one way valve in the second conduit and in fluid communication between the breather and atmosphere, and the check valve in the first conduit between the breather and the air intake of the turbocharger.

13. The system according to claim 12, wherein the check valve closes when the differential air pressure across the check valve is greater than the spring force holding the check valve open.

14. The system according to claim 13, wherein the spring force is set to counteract about a 5 inches of water differential pressure in a direction urging the check valve closed.
